(19) United States
(12) Patent Application Publication
(10) Pub. No.: US 2015/0369416 A1
(43) Pub. Date: Dec. 24, 2015

(54) Line Stop Adapter For Mechanical Joint Outlet

(71) Applicant: Robert E. Farrelly, Windsor, CT (US)

(72) Inventor: Robert E. Farrelly, Windsor, CT (US)

(21) Appl. No.: 14/742,829

(22) Filed: Jun. 18, 2015

Related U.S. Application Data
(60) Provisional application No. 62/015,001, filed on Jun. 20, 2014.

(51) Int. Cl. F16L 55/10

(52) U.S. Cl. CPC F16L 55/10

(57) ABSTRACT

A line stop adapter for use with a mechanical joint outlet has a body including a flange portion and a sleeve portion. The flange portion has oppositely disposed upper and lower mounting surfaces and an axial opening. The sleeve portion extends downwardly from an upper end to a lower end and has a bore. The flange portion opening and the sleeve portion bore define a body aperture extending between, and fluidly connecting, the flange portion upper mounting surface and the sleeve portion lower end. The sleeve portion bore includes upper, middle and lower sections defining upper, middle and a lower wall portions. The sleeve portion lower wall portion has a diameter that increases from the middle wall portion to the lower end defining a frustoconical shape.

### CROSS-REFERENCE TO RELATED APPLICATIONS

This application claims the benefit under 35 U.S.C. §119(e) of United States Provisional Patent Application Ser. No. 62/015,001 filed Jun. 20, 2014.

### BACKGROUND

The present disclosure relates generally to fittings used to temporarily stop the flow of fluid in a pipeline. It is more particularly concerned with an adapter to allow a tapping sleeve to be used as a line stop fitting.

Fluids are hereby defined to be any material that is non-solid in its natural condition or materials that may be converted to and maintained in a non-solid state. Some fluid distribution systems, such as for the distribution of potable water, have been used for over one hundred years. Such systems comprise a fluid source such as a well or filtration plant, a main or distribution line connected to the source and smaller lateral lines connecting the main line to users. The main line can range in size from four inches in diameter to thirty inches or more in diameter. The main line can also be formed from a variety of materials such as iron, steel, cement or polymer. Often, a new lateral line will be required to supply a new user. It is desirable to connect the new lateral line to the main line without shutting off fluid flow to other users connected to the main line.

To fluidly connect the new lateral line to the main line without shutting off fluid flow in the main line a tapping sleeve can be used. A tapping sleeve comprises two mating saddles that are oppessedly mounted over the pipeline. A gasket is disposed between one or both saddles and the pipeline. One of the saddle sections includes a radially projecting standoff terminating in a distal flange.

In use, one set of two saddles and a gasket is secured over the pipeline where connection with the new lateral line is desired. When the saddles are fastened the gasket is clamped between the pipe and the saddles, providing a fluid seal. A valve is secured to the saddle flange. A drilling apparatus is secured to the valve. The drilling apparatus is used to drill through the pipe, after which the drill is retracted and the valve is closed. The drilling apparatus is removed. The new lateral line is fluidly connected to the valve. When the valve is opened fluid is supplied to the new lateral line and the new user.

The valve is left secured to the tapping sleeve flange during use. Thus, there is no provision to fluidly seal the tapping sleeve flange apart from use of the secured valve.

In some instances, a distribution pipeline must be relocated. In other instances the distribution pipeline will break requiring repair. Often such work must be conducted quickly to return the distribution pipeline back into service. However, there may be no valve suitably positioned to turn off fluid flow in the main pipeline to allow the work to be conducted. In other cases it may not be possible to turn off fluid flow to the damaged section of pipeline without also turning off the flow to a critical user such as a hospital. In these cases a Aline stop fitting@ and system can be used. The line stop fitting comprises two mating saddles that are oppessedly mounted over the pipeline adjacent the section that has broken or that needs to be moved. A gasket is disposed between one or both saddles and the pipeline. One of the saddle sections includes a radially projecting standoff terminating in a distal flange.

In use, one or more saddles may be used. The first saddle and a gasket are secured over the main pipeline adjacent one side of the broken section. A second saddle (if required) and a gasket are secured over the main pipeline adjacent the opposing side of the broken section. When the saddles are fastened the gasket is clamped between the pipe and the saddles, providing a fluid seal. A temporary valve is secured to each saddle flange. A drilling apparatus is secured to each valve. The drilling apparatus is used to drill through the pipe, after which the drill is retracted and the valve is closed. The drilling apparatus is removed and a line stop apparatus is secured to each valve. The line stop apparatus comprises an expandable head in a fluid tight housing on a movable ram. In some variations, a temporary pipe connects the fluid tight housings of two or more line stop apparatus to allow fluid flow around the broken section. The temporary valve is opened and a head of the line stop apparatus is forced into the interior of the pipe. Expansion of the line stop head into the interior of the pipe prevents fluid from moving past the head, stopping fluid flow in the main pipeline only immediately adjacent the broken section and/or line stop apparatus. With fluid flow stopped by the line stop head repairs can be made.

After repairs have been made to the main pipeline, the line stop heads are retracted allowing fluid communication through the repaired pipe. The temporary valve(s) are closed and the line stop head is removed. A completion plug is placed into the line stop apparatus. The temporary valve(s) are opened and the completion plug is received into, and engaged with, the interior of line stop fitting flange. Typically, the completion plug is threadedly engaged with threads in the interior of the line stop flange or set screws within the saddle flange rim are engaged into a recess in the completion plug periphery. When the completion plug is received into, and engaged with, the line stop fitting flange fluid flow through the saddle flange is prevented. The line stop apparatus is removed, the temporary valve is removed and a blind flange and seal is placed over the top of the saddle flange.

Once the repair has been made there is usually no need to return to the repair site. Thus it is undesirable to leave the one or more valves, which can cost hundreds to thousands of dollars each, on the line stop flange. Hence the use of a relatively inexpensive completion plug and blind flange for sealing the line stop fitting.

While somewhat similar in appearance, a tapping sleeve and a line stop fitting can not be interchanged. The tapping fitting does not have provisions for use with a completion plug. Further, each manufacturer designs their line stop apparatus to work with their own respective line stop fitting. Thus, a line stop fitting from one manufacturer may not be compatible with a line stop apparatus from another manufacturer. To ensure quick repairs to essential distribution pipelines a maintenance department must stock a tapping sleeve for each pipeline size used in the fluid distribution network as well as a line stop fitting for each pipeline size used in the fluid distribution network. Since each line stop fitting can cost hundreds or thousands of dollars this double stocking requires a significant budget as well as room to store both the large tapping sleeves and the large line stop fittings.

### SUMMARY

There is provided a line stop adapter for use with a mechanical joint outlet comprising a body including a flange portion and a sleeve portion. The flange portion has oppositely disposed upper and lower mounting surfaces and an axial opening. The sleeve portion extends downwardly from an upper end to a lower end and has a bore. The flange portion opening and the sleeve portion bore define a body aperture extending between, and fluidly connecting, the flange portion upper mounting surface and the sleeve portion lower end. The sleeve portion bore includes upper, middle and lower sections defining upper, middle and a lower wall portions. The sleeve portion lower wall portion has a diameter that increases from the middle wall portion to the lower end defining a frustoconical shape.

The sleeve portion may extend from the flange portion lower mounting surface to the lower end.

The flange portion opening and the sleeve portion upper wall portion are adapted to receive and selectively engage a completion plug.

One of the upper, middle or lower wall portions of the body may define at least one radially extending aperture, with the line stop adapter including a pin disposed in the wall portion aperture. Movement of the pin radially inwardly into the body aperture allows selective engagement of the pin with a circumference of the completion plug.

At least one of the flange portion opening and the sleeve portion upper wall portion may comprise internal threads adapted to engage external threads on the completion plug.

The flange portion and the sleeve portion may have a substantially circular shape.

The body aperture may have a substantially circular shape.

The body includes multiple engagement portions arranged around the body aperture, the engagement portions are adapted to mount the body to a flange of a tapping sleeve.

The engagement portions may comprise multiple threaded studs extending from the flange portion lower mounting surface.

The flange portion may define multiple apertures arranged around the body aperture, with the engagement portions comprising bolts extending through the apertures.

The flange portion may include upper and lower flange segments defining the upper and lower mounting surfaces. The upper flange segment defines a first effective diameter and the lower flange segment defines a second effective diameter. The body also including a hub fluidically connecting the flange portion upper and lower mounting surfaces, with the hub defining an effective diameter different than either the first or second diameters.

The sleeve portion is disposed in the lower flange segment, the sleeve portion lower end being substantially coplanar with the flange portion lower mounting surface.

The body aperture includes upper, middle and lower portions, with the body aperture upper portion being adapted to receive and selectively engage a completion plug.

The body aperture upper portion may comprise internal threads adapted to engage external threads on the completion plug.

The body aperture upper portion may comprise at least one radially extending aperture, with the line stop adapter including a pin disposed in the radially extending aperture. Movement of the pin radially inwardly into the body aperture allows selective engagement of the pin with a circumference of the completion plug.

### BRIEF DESCRIPTION OF THE DRAWINGS

Referring now to the drawings wherein like elements are numbered alike in the several Figures:

FIG. 1 is an exploded side view of a conventional line stop fitting assembly;

FIG. 2 is an exploded end view of a conventional line stop fitting assembly;

FIG. 3 is a perspective view of one embodiment of a conventional tapping sleeve;

FIG. 4 is a side perspective view of one embodiment of a conventional mechanical joint outlet tapping sleeve;

FIG. 5 is a front perspective view of an alternate embodiment of the top saddle section of FIG. 4;

FIG. 6 is a perspective, partly in phantom, exploded view of a line stop adapter system for a mechanical joint outlet tapping sleeve having a single bolting flange; and

FIG. 7 is a perspective, exploded view of a line stop adapter system for a mechanical joint outlet tapping sleeve having top and bottom bolting flanges.

### DETAILED DESCRIPTION

For simplicity this disclosure will reference use with potable water systems, although it will encompass use with other fluidic systems including sewage, gas and chemicals. Pipes used to carry potable water spans sizes from under one inch to more than thirty inches and can be formed from numerous materials including iron, steel, cement and polymer. Pipes used to distribute water are called mains. Laterals are pipes that transport water from the distribution system to a user.

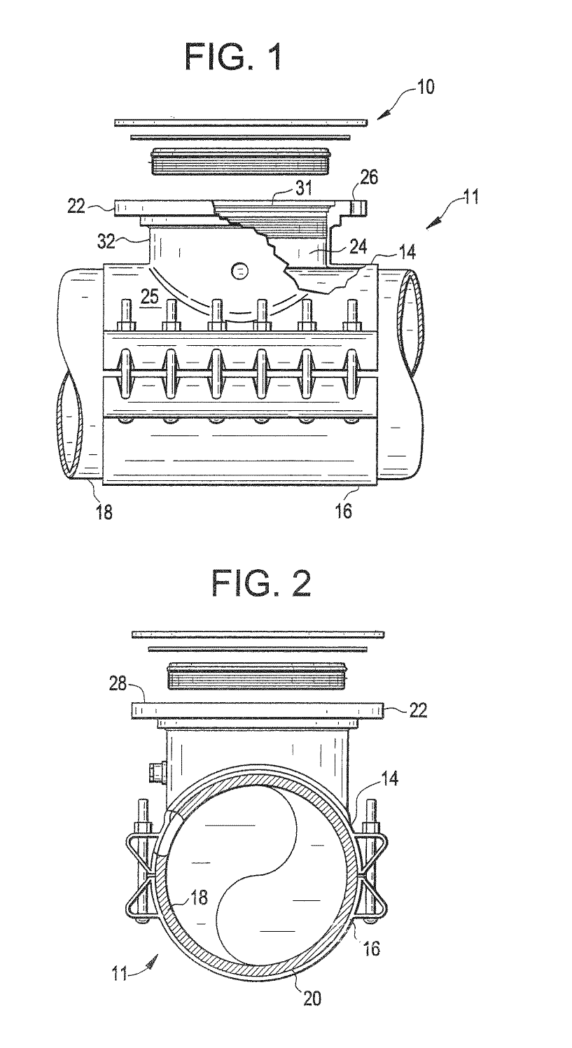

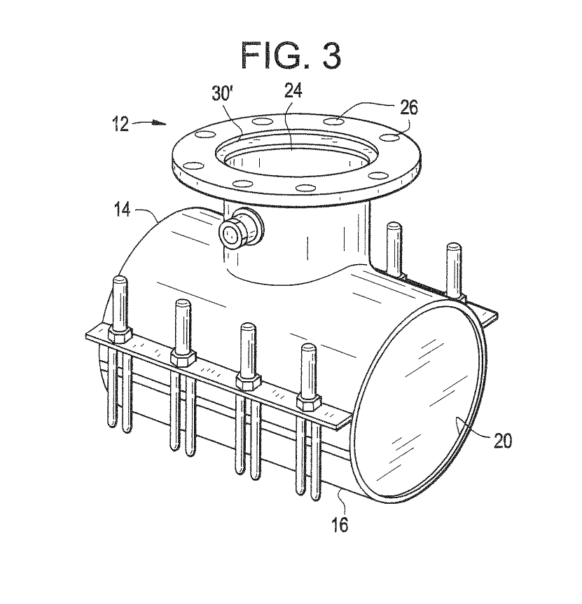

With reference to FIGS. 1-3, a line stop fitting 11 or tapping sleeve 12 comprises two, mating, semi-cylindrical saddle sections 14, 16 that can be oppessedly mounted over the pipe 18. A gasket 20 is disposable between one or both of the saddle sections 14, 16 and the pipe 18. One of the saddle sections 14 includes a radially projecting flange 22 defining a central aperture 24 fluidly connected to the saddle 25. The flange 22 is typically circular and defines a plurality of apertures 26 spaced around the central aperture 24. The flange 22 includes a mounting face 28. A recessed portion 30, 30′ extends below the mounting face 28 and around the central aperture 24. In a line stop fitting, the recessed portion is threaded 31 or pinned. In a tapping sleeve, the recessed portion 30′ accepts a mating projection in a tapping or permanent valve (not shown) to help center the valve to the flange 22. Typically, a cylindrical standoff 32 is disposed between the saddle 25 and the flange 22 to allow working clearance between the pipe 18 and the valve. U.S. Pat. No. 8,286,655 discloses a line stop adapter adapted to permit a conventional tapping fitting to be used in a line stopping operation. U.S. Pat. No. 8,286,655 is hereby incorporated by reference.

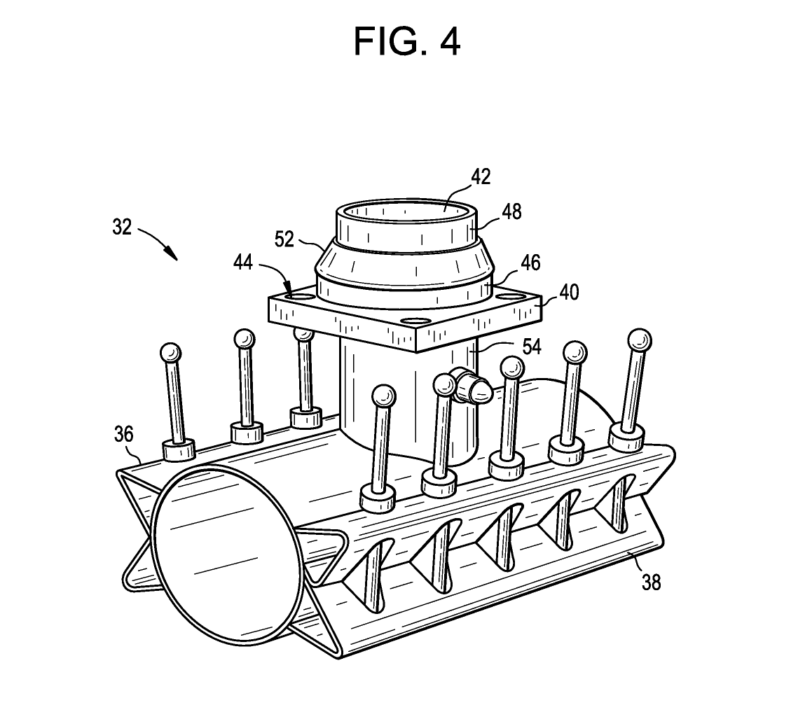

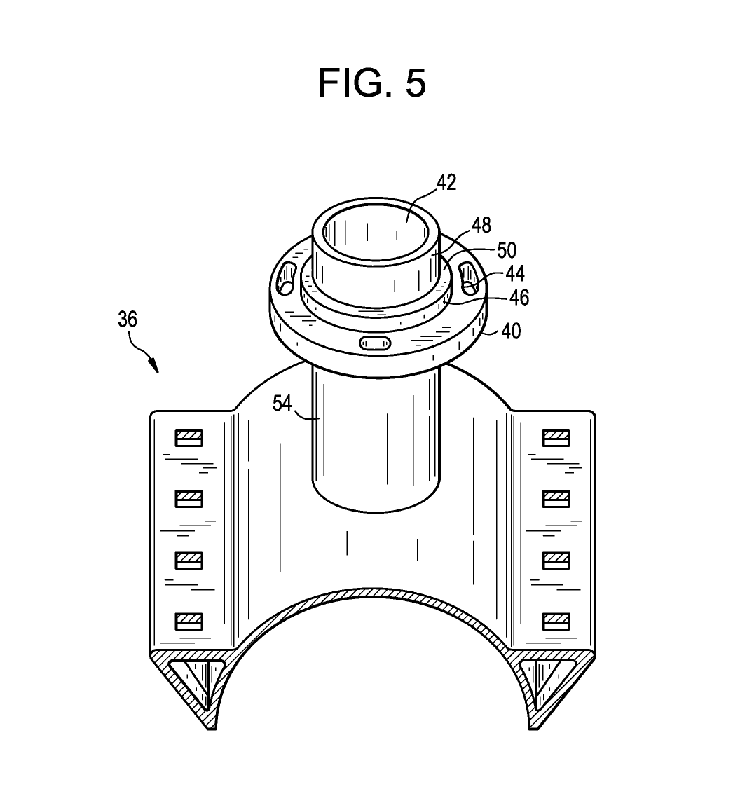

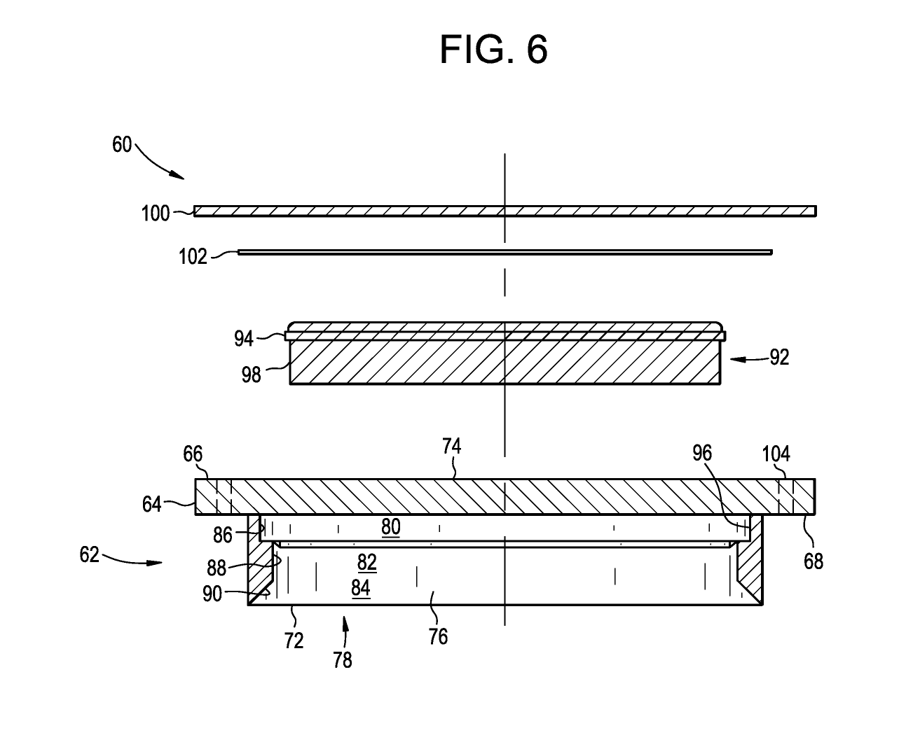

With reference to FIGS. 4 and 5, a mechanical joint outlet tapping sleeve 34 comprises two, mating, semi-cylindrical saddle sections 36, 38 that can be oppessedly mounted over the pipe. A gasket (not shown) may be disposed between one or both of the saddle sections 36, 38 and the pipe. One of the saddle sections 36 includes a radially projecting flange 40 defining a central aperture 42 fluidly connected to the saddle 36. The flange 40 may have a rectilinear shape (FIG. 4) or a circular shape (FIG. 5) and defines a plurality of apertures 44. The flange 40 includes a proximal first tubular protrusion 46 disposed around the central aperture 42 and a distal second tubular protrusion 48 disposed around the central aperture 42, the first and second protrusions 46, 48 forming a circular shoulder 50. A seal ring 52 may be disposed on the shoulder 50. Typically, a cylindrical standoff 54 is disposed between the upper saddle 36 and the flange 40 to allow working clearance between the pipe and the valve.

In one embodiment the line stop adapter system 60 for a mechanical joint outlet tapping sleeve 34 comprises a body 62 including a flange portion 64 having oppositely disposed upper and lower mounting surfaces 66, 68 and a sleeve portion 70 extending downwardly from an upper end 69 to a lower end 72. In the first embodiment, the sleeve portion extends downwardly from the flange portion lower mounting surface 68 to the lower end 72. Typically the flange portion 64 and the sleeve portion outer surface will be circular although this disclosure encompasses any advantageous shapes. The flange portion 64 has an axial opening 74 and the sleeve portion 70 has a bore 76 defining a body aperture 78 extending between, and fluidly connecting, the flange portion upper mounting surface 66 and the sleeve portion lower end 72. The sleeve portion bore 76 includes upper, middle and lower sections 80, 82, 84 defining upper middle and lower wall portions 86, 88, 90.

The flange portion opening 74 and the sleeve portion upper wall portion 86 are adapted to receive and selectively engage a completion plug 92. Typically the flange portion opening 74 and the sleeve portion upper wall portion 86 define a circular body aperture to receive a circular completion plug 92 and the completion plug 92 comprises a circumferential seal 94. Selective engagement of the flange portion opening 74 and the sleeve portion upper wall portion 86 with the completion plug seal 94 fluidly seals the body aperture 78 preventing fluid movement between the flange portion upper mounting surface 66 and the sleeve portion lower end 72. In one embodiment the flange portion opening 74 and the sleeve portion upper wall portion 86 comprise internal threads 96 which engage external threads 98 on the completion plug 92. In another embodiment the flange portion opening or the sleeve portion upper wall portion comprises a radially oriented aperture 99 connecting the exterior of the body with the body aperture. A pin 101 disposed within the wall portion aperture 99 can engage a recess in the completion plug to maintain the completion plug within the body aperture. The completion plug seal prevents fluid from reaching the wall portion aperture. In some variations the wall portion aperture is internally threaded to engage with external threads on the pin 101. A blind flange 100 and seal 102 can be mounted over the flange portion upper mounting surface 66 after the completion plug 92 is installed.

The sleeve portion middle wall portion 88 has a diameter selected to receive the second tubular protrusion 48 of the mechanical joint outlet tapping sleeve 34. That is, the diameter of the sleeve portion middle wall portion 88 is greater than the outside diameter of the second tubular protrusion 48. The sleeve portion lower wall portion 90 has a diameter that increases from the middle wall portion 88 to the lower end 72 defining a frustoconical shape.

The body 62 includes a plurality of engagement portions arranged around the body aperture 78 for securing the body 62 to the tapping sleeve flange 40. In some embodiments the engagement portions comprise studs fastened to the flange portion lower mounting surface and projecting outwardly therefrom. The studs are disposable through apertures in the tapping sleeve flange. Nuts can be engaged to the studs to secure the body to the tapping sleeve flange. In other embodiments the engagement portions comprise apertures 104 through the flange portion 64. Bolts are disposable through apertures 104, 44 in the body flange portion 64 and the tapping sleeve flange 40. Nuts can be engaged to the bolts to secure the body 62 to the tapping sleeve flange 40.

The flange portion upper mounting surface 66 is typically planar and adapted to provide a fluid tight joint when mounted to a valve. The flange portion upper mounting surface can include a recessed portion extending around part or the entire body aperture and recessed below the mounting surface. The recessed portion accepts a mating projection in a valve to help center the valve to the flange portion upper mounting surface 66.

In some embodiments, studs fastened to the flange portion upper mounting surface 66 and project outwardly therefrom. The studs are disposable through apertures in the valve. Nuts can be engaged to the studs to secure the flange portion upper mounting surface 66 to the valve. In other embodiments the engagement portions comprise body apertures 104. Bolts are disposable through body apertures 104 and apertures in the valve. Nuts can be engaged to the bolts to secure the flange portion upper mounting surface 66 to the valve.

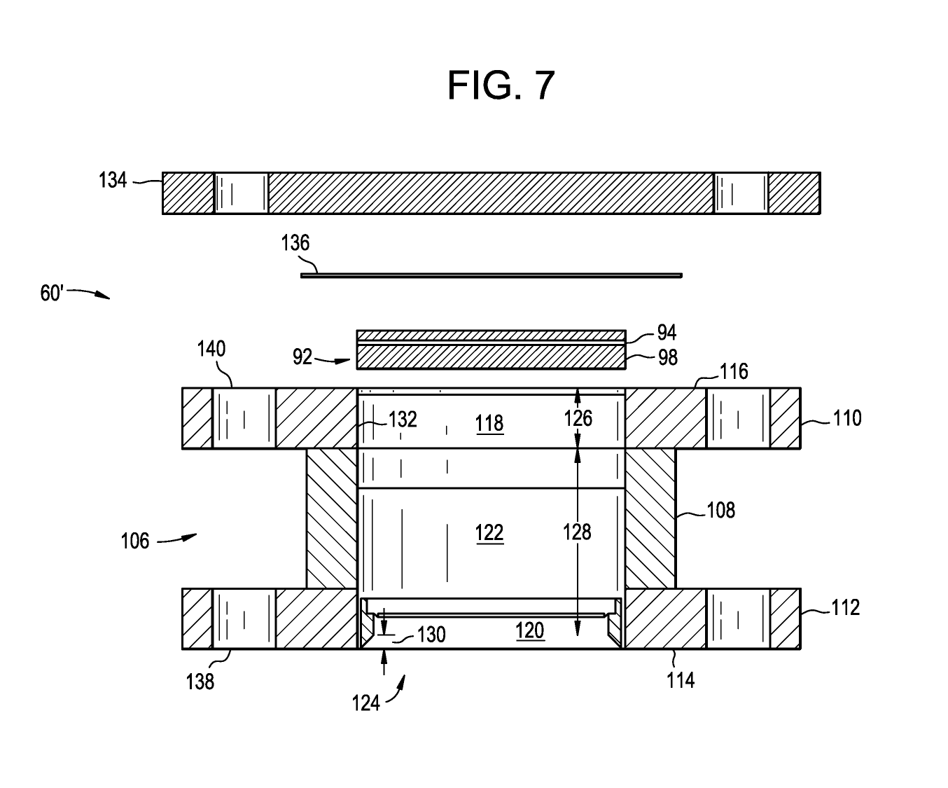

In a second embodiment, the line stop adapter system 60′ is advantageously used with pipe sizes over ten inches in diameter includes a body 106 having a hub 108 disposed between upper and lower flange segments 110, 112 defining lower and upper mounting surfaces 114, 116 (FIG. 7). Each flange segment 110, 112 has an axial opening 118, 120 and the hub 108 has a bore 122 having an interior wall defining a body aperture 124 fluidly connecting the mounting surfaces 114, 116. The body aperture 124 includes upper, middle and lower portions 126, 128, 130.

The body aperture upper portion 126 is adapted to receive and selectively engage a completion plug 92. Typically the body aperture upper portion 126 defines a circular opening to receive a circular completion plug 92 and the completion plug 92 comprises a circumferential seal 94. Selective engagement of the body aperture upper portion 126 with the completion plug seal 94 fluidly seals the body aperture 124 preventing fluid movement between the mounting surfaces 114, 116. In one embodiment the body aperture upper portion 126 comprises internal threads 132 which engage external threads 98 on the completion plug 92. In another embodiment the body aperture upper portion 126 comprises a radially oriented aperture connecting the exterior of the body with the body aperture. A pin can engage a recess in the completion plug 92 to maintain the completion plug 92 within the body aperture upper portion 126. A blind flange 134 and seal 136 can be mounted over the upper mounting surface 116 after the completion plug 92 is installed.

The body aperture middle portion 128 has a diameter selected to receive the second tubular protrusion 48 of the mechanical joint outlet tapping sleeve 32. That is, the diameter of the body aperture middle portion 128 is greater than the outside diameter of the second tubular protrusion 48. The body aperture lower portion 130 may have a diameter selected to receive the second tubular protrusion 48 of the mechanical joint outlet tapping sleeve 32 or it may have a diameter that increases from the body aperture middle portion 128 to the lower mounting surface 114, defining a frustoconical shape.

The body 106 includes a plurality of engagement portions arranged around the body aperture 124 for securing the body 106 to the tapping sleeve flange 40. In some embodiments the engagement portions comprise studs fastened to the lower mounting surface 114 and projecting outwardly therefrom. The studs are disposable through apertures 44 in the tapping sleeve flange 40. Nuts can be engaged to the studs to secure the body 106 to the tapping sleeve flange 40. In other embodiments the engagement portions comprise apertures 138 through the lower flange segment 112. Bolts are disposable through apertures 138, 44 in the body 106 and the tapping sleeve flange 40. Nuts can be engaged to the bolts to secure the body 106 to the tapping sleeve flange 40.

The upper mounting surface 116 is typically planar and adapted to provide a fluid tight joint when mounted to a valve. The upper mounting surface 116 can include a recessed portion extending around part or the entire body aperture 124 and recessed below the upper mounting surface 116. The recessed portion accepts a mating projection in a valve to help center the valve to the upper mounting surface 116.

In some embodiments, studs fastened to the upper mounting surface 116 and project outwardly therefrom. The studs are disposable through apertures in the valve. Nuts can be engaged to the studs to secure the upper mounting surface 116 to the valve. In other embodiments the engagement portions comprise body apertures 140. Bolts are disposable through body apertures 140 and apertures in the valve. Nuts can be engaged to the bolts to secure the upper mounting surface 116 to the valve.

While preferred embodiments have been set forth for purposes of illustration, the foregoing description should not be deemed a limitation of the disclosure herein. Accordingly, various modifications, adaptations and alternatives may occur to one skilled in the art without departing from the spirit and scope of the present disclosure.

What is claimed is:

1. A line stop adapter for use with a mechanical joint outlet comprising:
a body including a flange portion having oppositely disposed upper and lower mounting surfaces and a sleeve portion extending downwardly from an upper end to a lower end;
the flange portion having an axial opening and the sleeve portion has a bore, the flange portion opening and the sleeve portion bore defining a body aperture extending between, and fluidly connecting, the flange portion upper mounting surface and the sleeve portion lower end;
the sleeve portion bore including upper, middle and lower sections defining upper, middle and lower wall portions;
wherein the sleeve portion lower wall portion has a diameter that increases from the middle wall portion to the lower end defining a frustoconical shape.

2. The line stop adapter of claim 1 wherein the sleeve portion extends from the flange portion lower mounting surface to the lower end.

3. The line stop adapter of claim 1 wherein the flange portion opening and the sleeve portion upper wall portion are adapted to receive and selectively engage a completion plug.

4. The line stop adapter of claim 3 wherein one of the upper, middle or lower wall portions of the body defines at least one radially extending aperture and the line stop adapter includes a pin disposed in the wall portion aperture, whereby movement of the pin radially inwardly into the body aperture allows selective engagement of the pin with a circumference of the completion plug.

5. The line stop adapter of claim 3 wherein at least one of the flange portion opening and the sleeve portion upper wall portion comprise internal threads adapted to engage external threads on the completion plug.

6. The line stop adapter of claim 1 wherein the flange portion and the sleeve portion have a substantially circular shape.

7. The line stop adapter of claim 1 wherein the body aperture has a substantially circular shape.

8. The line stop adapter of claim 1 wherein the body includes a plurality of engagement portions arranged around the body aperture, the engagement portions being adapted to mount the body to a flange of a tapping sleeve.

9. The line stop adapter of claim 8 wherein the engagement portions comprise a plurality of threaded studs extending from the flange portion lower mounting surface.

10. The line stop adapter of claim 8 wherein the flange portion defines a plurality of apertures arranged around the body aperture, the engagement portions comprising a plurality of bolts extending through the apertures.

11. The line stop adapter of claim 1 wherein the flange portion includes upper and lower flange segments defining the upper and lower mounting surfaces, the upper flange segment defining a first effective diameter, the lower flange segment defining a second effective diameter, the body also including a hub fluidically connecting the flange portion upper and lower mounting surfaces, wherein the hub defines an effective diameter different than either the first or second diameters.

12. The line stop adapter of claim 11 wherein the sleeve portion is disposed in the lower flange segment, the sleeve portion lower end being substantially coplanar with the flange portion lower mounting surface.

13. The line stop adapter of claim 11 wherein the body aperture includes upper, middle and lower portions.

14. The line stop adapter of claim 13 wherein the body aperture upper portion is adapted to receive and selectively engage a completion plug.

15. The line stop adapter of claim 14 wherein the body aperture upper portion comprises internal threads adapted to engage external threads on the completion plug.

16. The line stop adapter of claim 14 wherein the body aperture upper portion comprises at least one radially extending aperture and the line stop adapter includes a pin disposed in the radially extending aperture, whereby movement of the pin radially inwardly into the body aperture allows selective engagement of the pin with a circumference of the completion plug.

17. The line stop adapter of claim 1 wherein the upper mounting surface defines a first effective diameter;
the lower mounting surface defines a second effective diameter and comprises opposing upper and lower surfaces radially extending from the body aperture, a plurality of apertures defined between the upper and lower surfaces and spaced around the body aperture; and
comprising a hub fluidically connecting the mounting surfaces, wherein the hub defines an effective diameter different than either the first or second diameters.

18. A line stop adapter for use with a mechanical joint outlet comprising:
a body including a flange portion having oppositely disposed upper and lower mounting surfaces, a sleeve portion extending downwardly from an upper end to a lower end, and a plurality of engagement portions arranged around the body aperture;
the flange portion having an axial opening and the sleeve portion has a bore, the flange portion opening and the sleeve portion bore defining a body aperture extending between, and fluidly connecting, the flange portion upper mounting surface and the sleeve portion lower end;
the sleeve portion bore including upper, middle and lower sections defining upper, middle and a lower wall portions;
the engagement portions being adapted to mount the body to a flange of a tapping sleeve;
wherein the sleeve portion lower wall portion has a diameter that increases from the middle wall portion to the lower end defining a frustoconical shape.
